(19) United States
(12) Patent Application Publication
(10) Pub. No.: US 2021/0313097 A1
(43) Pub. Date: Oct. 7, 2021

(54) POLYMERIC POSITIVE TEMPERATURE COEFFICIENT (PPTC) BODIES AND DEVICES MADE THEREFROM

(71) Applicant: Littelfuse, Inc., Chicago, IL (US)

(72) Inventors: Chun-Kwan Tsang, MORGAN HILL, CA (US); Jianhua Chen, SUNNYVALE, CA (US); Ann O. Banich, Chicago, IL (US)

(73) Assignee: Littelfuse, Inc., Chicago, IL (US)

(21) Appl. No.: 17/201,548

(22) Filed: Mar. 15, 2021

Related U.S. Application Data
(60) Provisional application No. 63/004,137, filed on Apr. 2, 2020.

(51) Int. Cl. H01C 7/02; H02H 9/02

(52) U.S. Cl. CPC H01C 7/027; H02H 9/026

(57) ABSTRACT

Polymeric positive temperature coefficient (PPTC) bodies and fuse devices formed therefrom are described. In various embodiments, the PPTC bodies comprise a matrix polymer and a conductive filler comprising a compound of general formula Mₙ₊₁AXₙ, where M is a transition d metal element, A is a p-block element, X is carbon or nitrogen, and n is 1, 2 or 3.

### CROSS REFERENCE TO RELATED APPLICATION

This application claims the benefit of priority to. U.S. Patent Application No. 63/004,137, filed Apr. 2, 2020, entitled “Polymeric Positive Temperature Coefficient (PPTC) Bodies And Devices Made Therefrom,” which application is incorporated herein

### BACKGROUND

### Field

Embodiments relate to the field of circuit protection devices, including fuse devices. by reference in its entirety.

### Discussion of Related Art

Polymer positive temperature coefficient (PPTC) devices may be used as overcurrent or over-temperature protection devices, as well as current or temperature sensors, among various other applications. In overcurrent or over-temperature protection applications, the PPTC device may be considered a resettable fuse, designed to exhibit low resistance when operating under designed conditions, such as low current. The resistance of the PPTC device may be altered by direct heating due to temperature increase in the environment of the circuit protection element, or via resistive heating generated by electrical current passing through the circuit protection element. For example, a PPTC device may include a polymer material and a conductive filler that provides a mixture that transitions from a low resistance state to a high resistance state, due to changes in the polymer material, such as a melting transition or a glass transition. At such a transition temperature, sometimes called a trip temperature, where the trip temperature may often range from room temperature or above, the polymer matrix may expand and disrupt electrically conductivity, rendering the composite much less electrically conductive. This change in resistance imparts a fuse-like character to the PPTC materials, which resistance may be reversible when the PPTC material cools back to room temperature.

### BRIEF SUMMARY

In some aspects, the present disclosure pertains to polymeric positive temperature coefficient (PPTC) bodies that comprise a material that contains (a) a polymer matrix and (b) a conductive filler comprising a compound of general formula Mₙ₊₁AXₙ, where M is a transition d metal element, A is a p-block element, X is carbon or nitrogen, and n is 1, 2 or 3.

In some embodiments, the p-block element may be selected from a Group IIIa, IVa, Va, or VIa element, such as Al, Si, P, S, Ga, Ge, As, Cd, In, Sn, Tl, and Pb.

In some embodiments, the transition metal may be a Group Mb, IVb, Vb, or VIb element, such as Ti, Sc, V, Cr, Zr, Nb, Mo, Hf, or Ta.

In some embodiments, the compound may be selected from Ti₂CdC, Sc₂InC, Ti₂AlC, Ti₂GaC, Ti₂InC, Ti₂TlC, V₂AlC, V₂GaC, Cr₂GaC, Ti₂AlN, Ti₂GaN, Ti₂InN, V₂GaN, Cr₂GaN, Ti₂GeC, Ti₂SnC, Ti₂PbC, V₂GeC, Cr₂AlC, Cr₂GeC, V₂PC, V₂AsC, Ti₂SC, Zr₂InC, Zr₂TlC, Nb₂AlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂AlC, Ta₂GaC, Hf₂SnC, Hf₂PbC, Hf₂SnN, Hf₂SC, Zr₂AlC, Ti₃AlC₂, Ti₃GaC₂, Ti₃InC₂, V₃AlC₂, Ti₃SiC₂, Ti₃GeC₂, Ti₃SnC₂, Ta₃AlC₂, Zr₃AlC₂, Ti₄AlN₃, V₄AlC₃, Ti₄GaC₃, Ti₄SiC₃, Ti₄GeC₃, Nb₄AlC₃, or Ta₄AlC₃.

In some embodiments, the polymer may be a semi-crystalline polymer, such as polyethylene (PE), polyvinylidene fluoride (PVDF), ethylene tetrafluoroethylene (ETFE), Ethylene-vinyl acetate (EVA), ethylene/acrylic acid copolymer (EAA), Ethylene Butyl Acrylate Copolymer (EBA), or Perfluoroalkoxy alkane polymers (PFA).

Other aspects of the present disclosure pertain to fuse devices that comprise (a) a PPTC body in accordance with any of the above aspects and embodiments; (b) a first electrode, disposed on a first side of the PPTC body; and (c) a second electrode, disposed on a second side of the PPTC body.

These and other aspects and embodiments will become apparent to those of ordinary skill in the art upon reviewing the Description of Embodiments and Claims to follow.

### BRIEF DESCRIPTION OF THE DRAWINGS

FIGS. 1A-1C illustrate PPTC devices according to embodiments of the disclosure;

FIGS. 2A and 2B illustrate PPTC devices according to further embodiments of the disclosure;

FIG. 3 illustrates exemplary resistance behavior for a PPTC device, according to an embodiment of the disclosure;

FIG. 4 shows a PPTC device according to various embodiments of the disclosure;

FIG. 5 shows a PPTC device according to various other embodiments of the disclosure;

FIG. 6 shows a PPTC device according to various additional embodiments of the disclosure; and

FIG. 7 shows a method of making PPTC devices according to various embodiments of the disclosure.

### DESCRIPTION OF EMBODIMENTS

The present embodiments will now be described more fully hereinafter with reference to the accompanying drawings, in which exemplary embodiments are shown. The embodiments are not to be construed as limited to the embodiments set forth herein. Rather, these embodiments are provided so that this disclosure will be thorough and complete, and will fully convey their scope to those skilled in the art. In the drawings, like numbers refer to like elements throughout.

In various embodiments, novel materials are described herein, which may be used to form PPTC bodies. The materials may contain a polymer and a conductive filler comprising a compound of general formula Mₙ₊₁AXₙ, where M is a transition d metal element, A is a p-block element, X is carbon or nitrogen, and n is 1, 2 or 3, which will be described in further detail below.

The PPTC bodies may be used to form devices, which may be configured to operate as fuse devices.

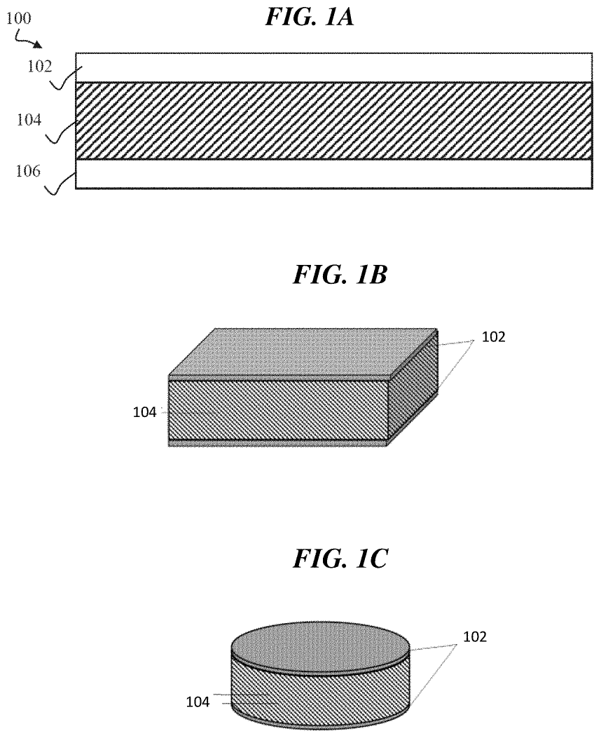

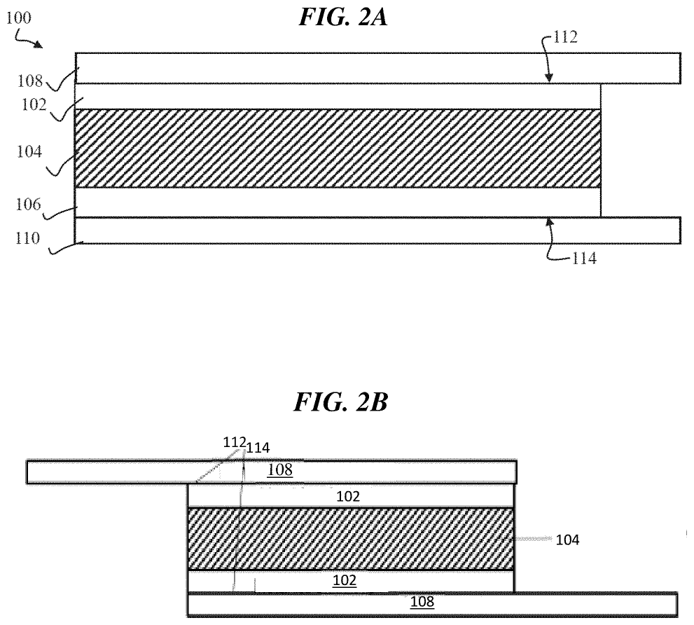

In various embodiments, PPTC devices may be constructed as shown in FIGS. 1A-1C. FIG. 1A illustrates a side cross-sectional view of a PPTC device 100, where a PPTC body 104 is disposed between a first electrode 102 and a second electrode 106, arranged on a first side and a second side, respectively, of the PPTC body 104. FIG. 1B illustrates a perspective view of a PPTC chip device 100, where a PPTC body 104 is disposed between a first electrode 102 and a second electrode 106, arranged on a first side and a second side, respectively, of the PPTC body 104. FIG. 1C illustrates a perspective view of a PPTC disc device 100, where a PPTC body 104 is disposed between a first electrode 102 and a second electrode 106, arranged on a first side and a second side, respectively, of the PPTC body 104.

In various embodiments, PPTC devices may be constructed as shown in FIG. 2A and FIG. 2B. FIG. 2A illustrates a configuration of a PPTC device 100 like that of FIG. 1A as a terminal device after a first terminal 108 is joined to the first electrode 102 and a second terminal 110 is joined to the second electrode 106. FIG. 2B illustrates a configuration of a PPTC device 100 like that of FIG. 1A as a strap device after a first terminal 108 is joined to the first electrode 102 and a second terminal 110 is joined to the second electrode 106.

According to embodiments of the disclosure, the PPTC body 104 may be formed as detailed below. The first electrode 102 and second electrode 106 may be formed of known metals, such as a copper foil. In some embodiments, the copper foil may be nickel plated. The first terminal 108 and second terminal 110 may also be formed of known materials, such a copper or brass. The first terminal 108 and the second terminal 110 may form a first interface 112 and second interface 114 with the first electrode 102 and second electrode 106, such as by welding. The embodiments are not limited in this context.

In various embodiments, the PPTC body 104 may be formed a material that contains a polymer matrix and a conductive filler.

In various embodiments, the polymer matrix of the PPTC body 104 may be formed a semi-crystalline polymer. Semi-crystalline polymers may be selected from, for example, polyethylene (PE), polyvinylidene fluoride (PVDF), ethylene tetrafluoroethylene (ETFE), Ethylene-vinyl acetate (EVA), ethylene/acrylic acid copolymer (EAA), Ethylene Butyl Acrylate Copolymer (EBA), or Perfluoroalkoxy alkane polymers (PFA). The embodiments are not limited in this context.

In various embodiments, the conductive filler of the PPTC body 104 may comprise a compound of general formula Mₙ₊₁AXₙ, where M is a transition d metal element, A is a p-block element, X is carbon or nitrogen, and n is 1, 2 or 3. In some of these embodiments, the p-block element may be selected from a Group IIIa, IVa, Va, or VIa element. Specific examples of such p-block elements include Al, Si, P, S, Ga, Ge, As, Cd, In, Sn, Tl, and Pb, among others. In some of these embodiments, the transition metal is selected from a Group IIIb, IVb, Vb, or VIb element. Specific examples of such transition metals may be selected from Ti, Sc, V, Cr, Zr, Nb, Mo, Hf, and Ta, among others. Examples of specific compounds in which n is 1 may be selected from Ti₂CdC, Sc₂InC, Ti₂AlC, Ti₂GaC, Ti₂InC, Ti₂TlC, V₂AlC, V₂GaC, Cr₂GaC, Ti₂AlN, Ti₂GaN, Ti₂InN, V₂GaN, Cr₂GaN, Ti₂GeC, Ti₂SnC, Ti₂PbC, V₂GeC, Cr₂AlC, Cr₂GeC, V₂PC, V₂AsC, Ti₂SC, Zr₂InC, Zr₂TlC, Nb₂AlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂AlC, Ta₂GaC, Hf₂SnC, Hf₂PbC, Hf₂SnN, Hf₂SC, or Zr₂AlC, among others. Examples of compounds in which n is 2 may be selected from Ti₃AlC₂, Ti₃GaC₂, Ti₃InC₂, V₃AlC₂, Ti₃SiC₂, Ti₃GeC₂, Ti₃SnC₂, Ta₃AlC₂, or Zr₃AlC₂, among others. Examples of compounds in which n is 3 may be selected from Ti₄AlN₃, V₄AlC₃, Ti₄GaC₃, Ti₄SiC₃, Ti₄GeC₃, Nb₄AlC₃, or Ta₄AlC₃. among others.

Such materials can combine certain properties of metals, such as good electrical and thermal conductivity, low hardness, machinability, damage tolerance and thermal shock resistance with those of ceramics, such as high temperature strength, high elastic moduli, oxidation and corrosion resistance. In some embodiments, the conductive filler of the PPTC body 104 may have a resistance that is less than 1×10⁻⁴ ohm-cm. In some embodiments, the conductive filler may have a resistance as low as about 2×10⁻⁵ ohm-cm. (Metals, on the other hand, have resistivities around 1-2×10⁻⁶ ohm-cm.)

In various embodiments, the conductive filler of the PPTC body 104 may be formed from particles having a particle size ranging from 0.2 μm to 100 μm, preferably 0.5 μm to 10 μm, more preferably, 1 μm to 4 μm, among other ranges.

In various embodiments, a volume fraction of the conductive filler in the PPTC body 104 ranges from 20% to 80%, preferably ranging from 30 to 50%. In various embodiments, a volume fraction of polymer matrix in the PPTC body 104 ranges from 80% to 20%, preferably ranging from 70 to 50%.

In addition to a matrix polymer and a conductive filler, PPTC bodies 104 in accordance with the present disclosure may further optionally comprise one or more of the following: (a) antioxidants such as commercially available Irganox 1010, Irganox HP1076, (b) process aids, such as Fluoropolymer Processing Aids, (c) anti-arcing filters, such as zinc oxide, calcium carbonate, manganese hydroxide, (d) anti-flammable compounds such as aluminum trihydrate, or (e) polymer crosslinking agents, such as triallyl isocyanurate.

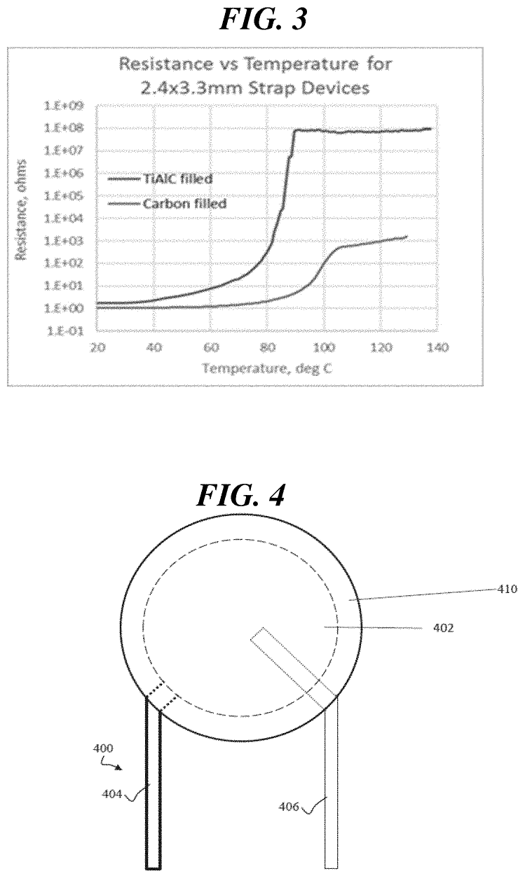

In various embodiments, PPTC bodies in accordance with the present disclosure can be used to form devices that exhibit an increase in resistivity of 10⁸ times. For example, turning now to FIG. 3 there is shown a graph plotting the resistance behavior as a function of temperature for two devices (a) a 2.4×3.3 mm strap device (top curve) containing a PPTC body in accordance with the present disclosure (specifically a PPTC body formed from 70 vol. % TiAlC particles in an EAA co-polymer matrix material) and (b) a 2.4×3.3 mm strap device (bottom curve) containing a PPTC body formed from 40 vol. % carbon particles in an EAA copolymer matrix material. As shown in FIG. 3, relative to the C-filled PPTC body, the TiAlC-filled PPTC body exhibits a much greater increase in resistivity with temperature, specifically exhibiting a resistance increase of approximately seven orders of magnitude.

In addition to those previously described, the configurations of PPTC device in accordance with the present disclosure may further vary according to different embodiments of the present disclosure. FIG. 4 presents a top plan view of a PPTC device 400, shown as radial lead PPTC device, including a bottom lead 404 and a top lead 406, attached to opposite surfaces of a PPTC body 402. The PPTC body 402 may have first and second electrodes (not separately shown) attached to the top surface and bottom surface thereof, respectively, as generally described above. The PPTC device 400 may be encapsulated by an encapsulant layer 410, such as an epoxy. The PPTC body 402 may be formulated as generally as described above.

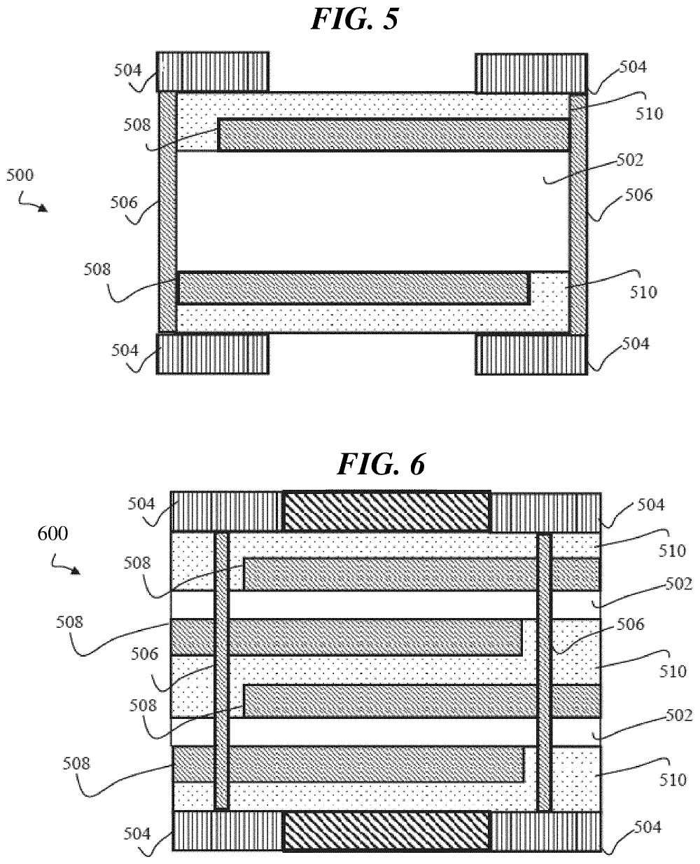

FIG. 5 and FIG. 6 depict side cross-sectional views of embodiments of a single layer surface mount PPTC device 500 and a double layer surface mount PPTC device 600, according to different embodiments of the disclosure. In these additional devices, the PPTC body may be formulated generally as described above. The PPTC device 500 and PPTC device 600 each have similar components, including metal electrodes 504, metallic traces 506, metal foil layers 508, PTC body 502, and insulation layers 510.

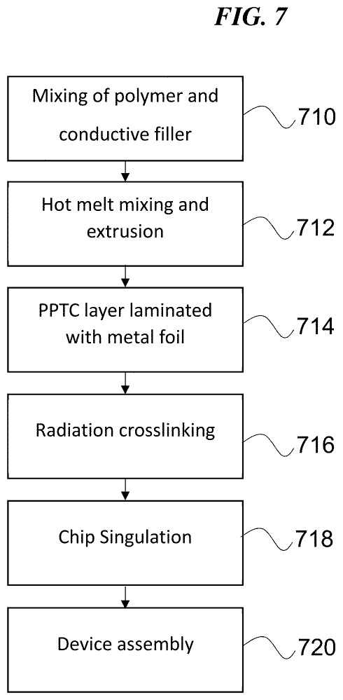

A process of forming a device in accordance with the present disclosure will now be described in conjunction with FIG. 7. In this process, the conductive polymers and matrix polymer are first mixed (710), followed by hot melt mixing and extrusion (712), lamination of PPTC layer with metal foil (714), radiation crosslinking (716), chip singulation (718) and, finally, device assembly (720).

While the present embodiments have been disclosed with reference to certain embodiments, numerous modifications, alterations and changes to the described embodiments are possible while not departing from the sphere and scope of the present disclosure, as defined in the appended claims. Accordingly, the present embodiments are not to be limited to the described embodiments, and may have the full scope defined by the language of the following claims, and equivalents thereof.

What is claimed is:

1. A polymeric positive temperature coefficient (PPTC) body, comprising:
a polymer and a conductive filler comprising a compound of general formula Mₙ₊₁AXₙ, where M is a transition d metal element, A is a p-block element, X is carbon or nitrogen, and n is 1, 2 or 3.

2. A PPTC body in accordance with claim 1, wherein the p-block element is selected from a Group IIIa, IVa, Va, or VIa element.

3. A PPTC body in accordance with claim 1, wherein the p-block element is selected from Al, Si, P, S, Ga, Ge, As, Cd, In, Sn, Tl, and Pb.

4. A PPTC body in accordance with claim 1, wherein the transition metal is a Group IIIb, IVb, Vb, or VIb element.

5. A PPTC body in accordance with claim 1, wherein the transition metal is selected from Ti, Sc, V, Cr, Zr, Nb, Mo, Hf, and Ta.

6. A PPTC body in accordance with claim 1, wherein the n is 1.

7. A PPTC body in accordance with claim 1, wherein the n is 2.

8. A PPTC body in accordance with claim 1, wherein the n is 3.

9. A PPTC body in accordance with claim 1, wherein the compound is selected from Ti₂CdC, Sc₂InC, Ti₂AlC, Ti₂GaC, Ti₂InC, Ti₂TlC, V₂AlC, V₂GaC, Cr₂GaC, Ti₂AlN, Ti₂GaN, Ti₂InN, V₂GaN, Cr₂GaN, Ti₂GeC, Ti₂SnC, Ti₂PbC, V₂GeC, Cr₂AlC, Cr₂GeC, V₂PC, V₂AsC, Ti₂SC, Zr₂InC, Zr₂TlC, Nb₂AlC, Nb₂GaC, Nb₂InC, Mo₂GaC, Zr₂InN, Zr₂TlN, Zr₂SnC, Zr₂PbC, Nb₂SnC, Nb₂PC, Nb₂AsC, Zr₂SC, Nb₂SC, Hf₂InC, Hf₂TlC, Ta₂AlC, Ta₂GaC, Hf₂SnC, Hf₂PbC, Hf₂SnN, Hf₂SC, or Zr₂AlC.

10. A PPTC body in accordance with claim 1, wherein the compound is selected from Ti₃AlC₂, Ti₃GaC₂, Ti₃InC₂, V₃AlC₂, Ti₃SiC₂, Ti₃GeC₂, Ti₃SnC₂, Ta₃AlC₂, or Zr₃AlC₂.

11. A PPTC body in accordance with claim 1, wherein the compound is selected from Ti₄AlN₃, V₄AlC₃, Ti₄GaC₃, Ti₄SiC₃, Ti₄GeC₃, Nb₄AlC₃, or Ta₄AlC₃.

12. A PPTC body in accordance with claim 1, wherein the conductive filler comprises particles having a particle size ranging from 0.5 μm to 10 μm.

13. A PPTC body in accordance with claim 1, wherein the polymer is a semi-crystalline polymer.

14. A PPTC body in accordance with claim 1, wherein the polymer is selected from polyethylene (PE), polyvinylidene fluoride (PVDF), ethylene tetrafluoroethylene (ETFE), Ethylene-vinyl acetate (EVA), ethylene/acrylic acid copolymer (EAA), ethylene butyl acrylate copolymer (EBA), perfluoroalkoxy alkane polymers (PFA), polyolefin elastomer (POE), polyethylene oxide (PEO), and chloroprene rubber.

15. A PPTC body in accordance with claim 1, wherein the volume fraction of polymer in the PPTC body ranges 20 to 80%.

16. A PPTC body in accordance with claim 1, wherein a volume fraction of the conductive filler in the PPTC body ranges from 20% to 80%.

17. A fuse device, comprising:
a PPTC body in accordance with claim 1;
a first electrode disposed on a first side of the PPTC body; and
a second electrode disposed on a second side of the PPTC body.

18. The fuse device of 17, selected from a chip device, a disc device, a terminal device, a strap device, a radial leaded device, a single layer surface mount device, or a double layer surface mount device.
